(19) United States
(12) Patent Application Publication
(10) Pub. No.: US 2003/0158798 A1
(43) Pub. Date: Aug. 21, 2003

(54) Rules-based accounting system for securities transactions

(76) Inventor: Philip M. Green, Old Bridge, NJ (US)

Correspondence Address: BRYAN CAVE LLP, 245 Park Avenue, New York, NY, 10167, US

(21) Appl. No.: 10/077,429

(22) Filed: Feb. 15, 2002

(51) Int. Cl. G06F 17/60

(52) U.S. Cl. 705/30

(57) ABSTRACT

A rules-based accounting system and method for accounting for transactions, comprises a transaction engine for receiving transaction events, an accounting engine for determining a set of rules to apply to the transaction event, deriving accounting information for the transaction based on the set of rules, and posting the derived accounting information to the account. The transaction events are processed as they are received and reconstruction is performed where the transactions are not received in proper order. The set of rules to be applied to the transaction event are determined by a cost basis, transaction classification, asset classification and event type. Rules may added, changed or removed by the user as needed.

### BACKGROUND

Computerized accounting systems are commonly used to assist in processing securities transactions. These systems partially automate the execution and accounting of securities transactions, including collecting and adjusting sums and accounts. These systems also partially automate the preparation of financial statements, the generation of account closing reports, and the reporting of other information required by investment managers, accountants, and others interested in monitoring the transactions.

As used herein, a transaction refers to the trade of assets, including financial instruments as well as commodities. Assets can include, for example, stocks, bonds, money markets, currency, gold, silver, oil, gas and other precious minerals and metals as well as any combinations of these. Derivatives of underlying assets such as options, swaps and futures, may also be the subject of a securities transaction.

In the securities industry, transactions are initiated primarily by brokers, traders, and investment managers such as fund and plan managers. Those entities initiating a transaction will be referred to collectively herein as “managers”. In addition to managers in the securities industry there are typically custodians that ensure the safekeeping of the assets and maintain records of the asset structure and changes in the asset structure. Custodians typically receive electronic records of transactions from managers, make sure the transactions settle and reconcile the transactions with the fund or plan.

Transactions may be recorded using various accounting rules. The choice of the appropriate accounting rule may vary depending on the nature of the asset being traded; the needs of the individual requiring the accounting information; and, industry, government or other regulatory rules that may apply to the transaction, as well as other factors. Certain accounting rules and guidelines are set forth in the Generally Accepted Accounting Principles (GAAP), which is promulgated by the Financial Accounting Standards Board (FASB), a self-regulatory organization for the accounting industry in the United States. For certain types of transactions, GAAP offers a choice of various accounting methodologies that may be employed so long as the methodology is used consistently. For example, in accounting for purchase and sale of securities, either the FIFO (First In, First Out) or LIFO (Last In, First Out) method may be used.

Different assets may also require different accounting rules. For example, the accounting rule for a fixed-income treasury bond paying monthly income would differ from the accounting rule for a common stock. The accounting rule for the fixed-income treasury bond would be required to take into account both the principal plus any income, whereas there is no income aspect to a trade for the common stock. As another example, some types of financial instruments, for example common securities, require determination of cost at the time of the trade date. Other types of financial instruments, such as those where settlement is less certain, may require determination of cost at time of settlement. New types of financial instruments or synthetic derivatives are commonly created and these may also require accounting rules different from those of existing financial instruments.

Certain business segments, such as the insurance industry, or the governments of other countries may have their own set of accounting requirements that differ from GAAP. For this reason, different account holders may follow different accounting rules for accounting for the same type of transaction. In addition, an individual account holder may keep several sets of accounting books in which the same transaction is recorded, each book following a different set of accounting rules. For example, even within a single business enterprise, different accounting needs may be required by master-trust accounting rules (employee benefits), mutual fund accounting, insurance accounting, and investment managing.

To make accounting even more complicated, accounting rules may change over time. It is therefore difficult for conventional accounting systems to apply the appropriate accounting rules consistently for every transaction.

Each transaction has a date and time (“date-time”) associated with it. The date-time of the transaction determines the proper order for processing transactions to an account. The difficulty lies in that transaction data are not always received by the accounting system in proper date-time order. Therefore transactions will not necessarily be processed in the proper order if they are processed as they are received. Typical computerized accounting systems will instead process all transactions at the end of the day by a batch process. Although these systems can re-sort the transactions for the day in the proper order before processing, the accounts are not up to date throughout the day. Furthermore, for those transactions not received on the proper day, manual intervention is required to make an adjustment.

For the above reasons, existing computerized accounting systems are unable to meet the various accounting needs of users and to provide real-time accounting or transactions.

### SUMMARY

The present invention is directed to a rules-based computerized accounting system and method for accounting for securities transactions. An accounting system having features of the present invention comprises a transaction engine for receiving transaction events. The transaction engine determines whether reconstruction is needed based on the date-time of a received transaction event and if needed, will reconstruct the account so that the transactions are posted to the account in proper order. The transaction engine forwards the transaction event to an accounting engine for determining a set of accounting rules to apply to the transaction, deriving accounting information for the transaction event according to the set of accounting rules, and posting the derived accounting information. The derived accounting information for the transaction events are stored to an accounting database.

The system can provide accounting of the data in accordance with different accounting rules and methodologies simultaneously to suit the needs of various users. The system can also post transactions in proper order as the transactions are received rather than using a batch process.

### DRAWINGS

These and other features, aspects, and advantages of the present invention will become better understood with regard to the following description, appended claims, and accompanying drawings where:

FIG. 1 is a block diagram illustrating the primary components of a system that operates in accordance with a preferred embodiment of the present invention.

FIG. 2 shows a schematic view illustrating the scalable, parallel architecture of an accounting system in accordance with one embodiment of the present invention.

FIG. 3 shows an illustration of a derivation process performed for an example transaction by the accounting system of FIG. 1.

FIG. 4 shows an illustration of a posting process performed for an example transaction by the accounting system of FIG. 1.

### DESCRIPTION

The current invention's system provides real time processing capabilities and posting capabilities without reliance on end of day batch processing. The system can provide accounting for various types of transactions according to various accounting rules.

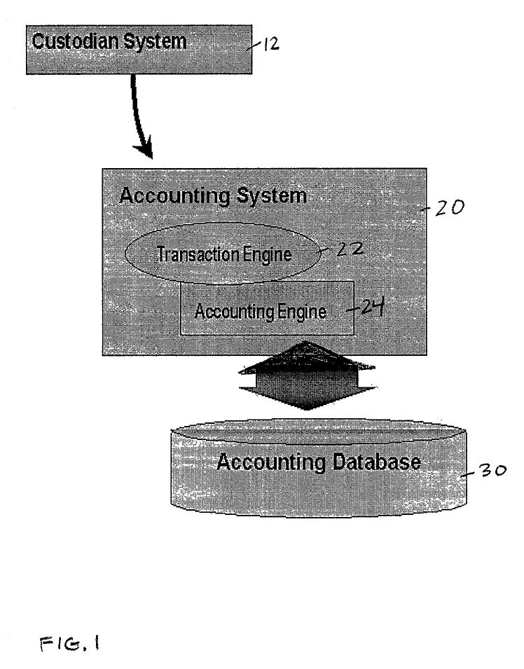

FIG. 1 is a block diagram illustrating the primary components of a system that operates in accordance with a preferred embodiment present invention. The system includes a custodian system (12), an accounting system (20) and an accounting database (30).

The custodian system (12) is connected to the accounting system (20) by a computer network or any other suitable means of connection. Alternatively, the accounting system (20) may be part of the custodian system (12).

The accounting system (20) includes a transaction engine (22) and an accounting engine (24). The accounting system (20) is connected to the accounting database (30) through a network or other connection, or, alternatively, the accounting database (30) may be part of the accounting system (20).

In operation, the custodian system (12) sends transactions and events to the accounting system (20). The transactions may originate within the custodian system itself, or, more typically, the custodian system (12) receives electronic records of transactions from a broker, trader, investment manager or other asset manager, possibly through a third-party service such as SWIFT (not shown) or any other suitable means. SWIFT (“Society for Worldwide Interbank Financial Telecommunication”) is an industry owned cooperative supplying secure messaging services and interface software to over 7,000 financial institutions in 196 countries. The transaction contains a transaction identifier and basic transaction information including, for example, the account to which the transaction pertains, quantity, base price, the asset being purchased, relevant commissions and fees, and the date and time (“date-time”) of the transaction.

A transaction has a life cycle comprised of transaction events or milestones. For example, the events in the life cycle of a transaction may include the date the transaction was created (the “trade date”), verification, pending, and settlement. Other type of transactions may have different life cycle events. Upon each event in the life cycle of a transaction, the custodian system (12) typically sends an event to the accounting system (20) for each event in the life cycle of the transaction as each event occurs. The event contains a transaction identifier, linking the event to a transaction, and information pertaining to the type of event in the life cycle of the transaction.

The transaction engine (22) of the accounting system (20) receives transactions from the custodian system (12) and stores a record of the transaction in the accounting database (30).

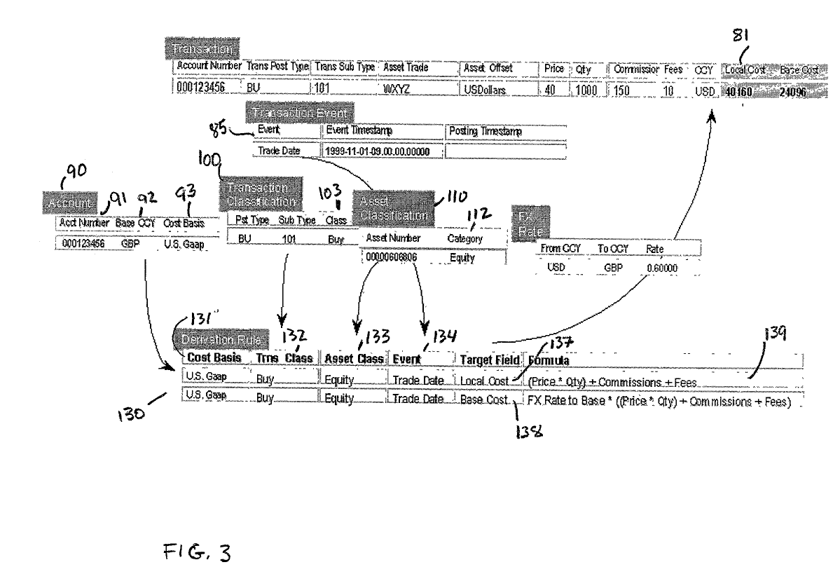

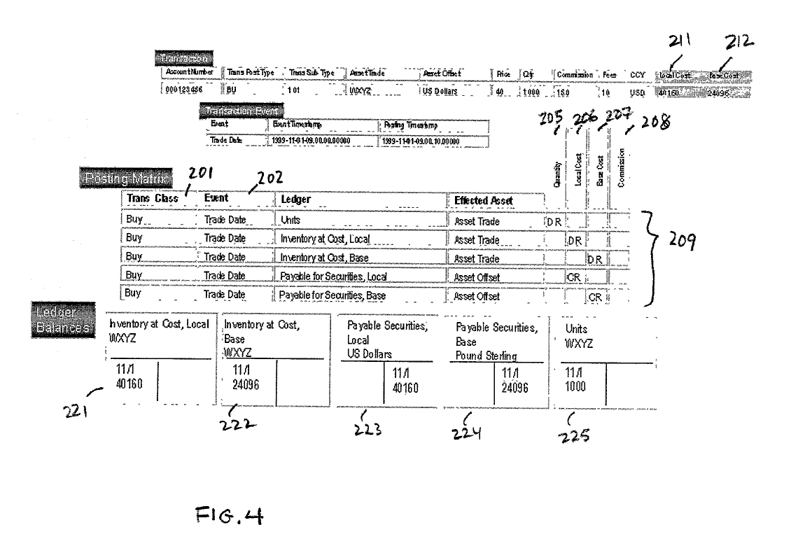

The transaction engine (22) also receives events from the custodian system (12). Upon receipt of an event, the transaction engine (22) associates the event with the appropriate transaction record previously stored in the accounting database (30). The event and its associated transaction information are referred to herein collectively as the “transaction event”. The transaction engine (22) then determines whether reconstruction is required based on the date-time of the transaction event as compared to the date-time of previously posted transaction events for the account. If required, reconstruction, described in more detail below, is performed. The transaction event is then forwarded to the accounting engine (24) for derivation and posting, which are described in further detail below in connection with FIGS. 3 and 4, respectively.

The process of reconstruction is used to ensure that transaction events are processed in the proper order to an account regardless of whether the transactions and events are received by the accounting system in proper date-time order. Upon receiving a transaction event, the transaction engine (22) of the accounting system (20) searches the records of previously posted transaction events in the accounting database (30) to determine whether reconstruction is necessary. Where the date-time of an earlier received transaction event for the account is later than that of the received transaction event and reconstruction is necessary, the transaction engine (22) will interact with the accounting engine (24) to undo the posting of the earlier received transaction event, derive and post the current transaction event, and subsequently re-derive and post the earlier received transaction event. Thus, transaction events are posted to the accounting database (30) on an ongoing basis while maintaining the proper order of posting for transactions events that have been received.

In order to post a transaction event, the transaction engine (22) forwards the transaction event to the accounting engine (24). The accounting engine (24) performs the derivation and posting processes described in more detail below in connection with FIGS. 3 and 4, respectively.

The accounting engine (24) can also produce snapshots (or views) of the account at scheduled times as required by the user, for example for auditing and reporting purposes. A snapshot is taken of the account by storing copies of the transaction and events pertaining to the account to the accounting database (30).

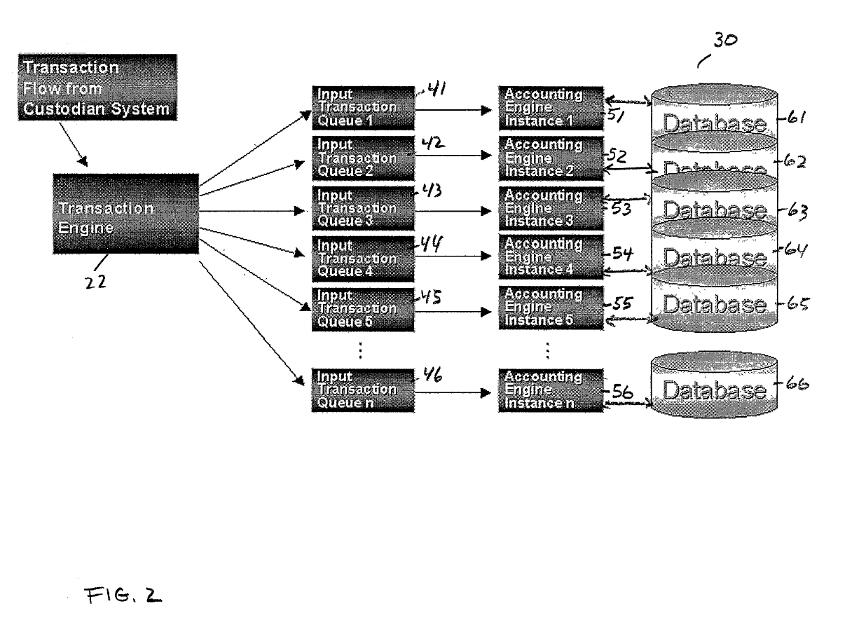

FIG. 2 illustrates the scalability of an embodiment of the present invention. When necessary, additional instances (51-56) of the accounting engine (24) and additional partitions (61-66) of the database (30) may be added to the system as transaction and account volume increases. Each instance (51-56) of the accounting engine (24) has an associated input queue (41-46). These instances operate in parallel providing for scalability of the accounting system (20). An account is assigned to one of the instances (51-56) of the accounting engine (24). The transactions are distributed by the transaction engine (22) to the one of the input queues (41-46) based on which instance (51-56) to which the account has been assigned. As shown in FIG. 2, each instance of the accounting engine (51-56) is also associated with a database partition (61-66).

The two most basic aspects of accounting, determination of cost and update of position, are performed by the accounting engine (24) through the derivation and posting processes, respectively. A position is the intersection between an account and a financial instrument.

In general, the derivation process takes the transaction event and applies a set of accounting rules to derive additional accounting information relating to the transaction event, for example the net cost or the gain or loss resulting from the transaction event, and updating the record for the transaction event to include this additional information.

Accounting rules for derivation are entered into the system by the user and are stored by the system in the accounting database (30). Rules may pertain to accounting rules such as GAAP rules or may pertain to other calculations desired by the user. Multiple rules may be entered for various calculations pertaining to a single transaction. Preferably, the rules would be entered into the system by the user through a Graphical User Interface (GUI) using a scripting language. As an example, a basic derivation rule would state that the cost of a transaction is the product of the number of shares being traded and the price per share, plus commissions and fees. In this case, the rule in scripting language would be “(Shares*Price)+Commissions+Fees”.

New accounting rules may be added and existing rules changed or removed through the GUI as need requires. Therefore the system is able to immediately take into account new accounting needs as they arise without the need to update the software. Rules are preferably time-stamped and archived in the accounting database. This allows the user to view a past version of a rule that may be associated with a past transaction. Rules may also be provided with an “effective date” and an “expiration date”. Rules are also preferably viewable with a transaction or transaction event, thereby providing explanation as to how the result of a calculation was reached.

FIGS. 3 and 4 illustrate the derivation and posting processes, respectively, for a simple securities transaction. In this example, the transaction is a buy order for 1,000 shares of Company WXYZ at $40 per share, plus $150 in commissions and $10 in fees.

Referring to FIG. 3, the accounting engine (24) determines which derivation rule or rules to apply to the transaction by looking up the rule or rules in the Derivation Rule table (130) stored in the accounting database (30). The accounting engine (24) determines which rule or rules to apply by a combination of four factors: the cost basis (131), transaction classification (132), asset classification (133) and event (134).

The cost basis (131) in general represents the set of accounting rules or treatments defined for a particular market segment. An account may have more than one cost basis where, for example, the account holder wishes to keep several sets of books, each following different accounting rules. In the example illustrated in FIG. 3, the cost basis (93) for the account (91) of the transaction is the U.S. GAAP Cost rule.

A second factor determining which derivation rules to apply is the type or classification of transaction (132) being executed. Multiple transaction types may be grouped into a classification in the transaction classification table (100), and a single rule may be used to pertain to all types within the classification, thus minimizing the number of rules that need to be maintained within the system. For example, a transaction classification may be created for “business expenses”, which may include a various different types of business expenses. In the example illustrated in FIG. 3, the transaction classification (103) is “Buy”.

The type or classification (133) of the asset or financial instrument of the transaction is also a factor in determining the derivation rules to apply to the transaction. In the same way that a category of transactions is grouped, a category of assets is grouped with an asset classification in an asset classification table (110). In the example illustrated in FIG. 3, the asset, WXYZ, is classified in the asset classification table (110) as “Equity” (112). Other asset classifications may include, for example, bonds, cash, precious metals, real estate, etc.

A fourth factor in determining the derivation rule to apply is the event (134) of the transaction. In FIG. 3, the event that has been reached in the transaction life cycle is “trade date” (85), which is the first event in the life cycle of the transaction.

In this example, based on the above four factors (U.S. GAAP Cost Basis, Buy, Equity and Trade Date), there are two rules that are applicable: one for local cost (137) and another for base cost (138). To determine local cost, the derivation rule applied in the example of FIG. 3 is “(Price*Quantity)+Commissions+Fees” (139). The accounting engine (24) performs the calculation of (1000*40)+150+10=40160, and places the number 40160 in the local cost field (81) of the transaction record.

Although the preferred embodiment uses these four factors to determine the applicability of the derivation rules, it should be understood by one of ordinary skill in the art that fewer, more, and/or different factors may be used than the ones used here.

FIG. 4 illustrates the posting process for the example of FIG. 3. In general, the posting process involves taking the data for the transaction, which includes both the original transaction information plus the additional information provided by the derivation process (the “extended transaction”), and debits and credits the appropriate balances to ledgers within an account. In accordance with principles of conventional double entry bookkeeping, each sum of the debit and credit adjustments for each transaction always equal zero. The accounts are always balanced, meaning that the assets of the account are equal to the sum of the liabilities plus owner's equity (i.e., capital).

The accounting engine (24) determines the debits and credits to be applied to applicable ledger balances by utilizing rules embedded in a posting matrix. The posting matrix is a matrix that contains a series of 0, 1 and −1 values. The zeroes represent a null posting effect. The value of 1 represents a debit action while −1 represents a credit action. Updates are performed through matrix multiplication in which data of the fields of the transaction event are multiplied by the posting matrix.

The posting matrix is created and maintained by the user, typically an accountant, preferably using a graphical user interface (GUI). Preferably, the GUI allows the user to select a transaction classification to view the posting rules for that transaction classification. The posting rules are preferably viewed as a matrix having rows for the ledgers and columns for the transaction fields, with the intersection of the rows and columns indicating “debit” or “credit” where applicable.

The posting rules are keyed based on transaction classification (201) and event (202). There may be zero or more posting rules triggered based on each combination of transaction classification and event. In the example shown in FIG. 4, five different rules (209) are triggered by the transaction. Each rule specifies the ledger to which the debit or credit is to applied. The balance of the target ledger will be either debited or credited with the amount indicated in the appropriate field of the transaction record, which in this case is 40160 for Local Cost (211) and 24096 for Base Cost (212). There is a set of ledgers for each account for each instrument. In the example shown in FIG. 4, debit balances are posted for both “Inventory At Cost, Local” (221) and “Inventory At Cost, Base” (222) ledgers, with equal and offsetting credit entries being made to the “Payable Securities, Local” ledger (223), which represents U.S. Dollars, and “Payable Securities, Base” ledger (224), which represents Pound Sterling. This highlights that the financial postings for this transaction have equal and offsetting debit and credit balances in keeping with generally accepted accounting principles. In addition, there is a posting to the Units ledger (225), which would be considered non-financial, showing that 1000 Units have been purchased.

The system posts to ledgers at each event in the life cycle of a transaction. In the example shown in FIG. 4, the postings are for the point in time when the trade was executed (“trade date”) (202). When the purchase of securities settles, a new transaction event for the settlement date, which has its own set of rules, will be posted to the ledgers.

Snapshots (views) of an account are performed on a scheduled basis and are also stored in the accounting database (30). Preferably snapshots are taken on a regular basis so that the account can be viewed as of any point in time at a later date. Account reconstruction is automatically performed to the snapshots based on transaction and events that are received after a the snapshot is taken. The user may “lock” a snapshot so that it is no longer updated by later received transaction events. Using snapshots, comparisons can be made, for example, to determine how the portfolio looks before and after the account reconstruction caused by a late trade. Comparisons may also be made between the current position and an earlier snapshot.

The journal entry, which is the application of the derived debit or credit for a transaction to the appropriate ledger balance, can later be recreated by the system using the original transaction record and the time-stamped derivation and posting rules. Therefore journal entries may be maintained as “virtual” entries and there is no need for the accounting system to store journal entries separately.

The present system also allows for multiple “sets of books” per account. A set of books refers to the combination of cost basis and base currency. As shown in FIG. 3, the database includes an account table (90) associating an account number (91) with a cost basis (93) and base currency (92). Although there is only one record shown for the account in FIG. 3, there may be more than one record in the table (90) for each account. The default cost basis or set of rules is primarily based on U.S. Generally Accepted Accounting Practices. However, the system has the capability of housing and executing many sets of rules specialized for various business segments, such as the insurance industry, or for country-specific requirements, e.g. U.K. Pension Plans. An example where a multiple set of books would be useful is in the case of a multinational corporation, which may need to report its financial data in several countries, each having different accounting rules and requirements.

Each set of books has a base currency for the purpose of standardized accounting of cost and gain/loss. Economic values of a transaction are converted from their native currency to the base currency associated with the set of books. For each set of books, a complete set of ledger balances is kept for the purpose of financial reporting.

The previously described embodiments of the invention have many advantages, including maintaining accounts up to date as each transaction is received rather than deferring the posting of the transaction until a batch process is run at the end of the day. Because batch processing is not needed, the system has greater availability than conventional accounting systems. Reconstruction is automatically performed by the invention when a transaction is received out of order.

The accounting logic is rules-driven to allow for flexibility. The system is flexible enough to handle multiple, concurrent sets of accounting treatments and multiple and concurrent sets of base currencies. The dynamic nature of the system and its use rules-based, updateable logic allows it to process the many different types of funds, plans and assets and to deal with the needs of various users and accounts and to handle new and changing accounting rules as they arise without updating the software. As an additional aspect of the present invention, full double entry accounting is provided.

Yet another benefit of the previously disclosed embodiments is the scalability of performance to handle increases in transaction and account volume by distributing accounts to multiple input queues \to be processed by multiple instances of the accounting engine.

Although the present invention has been described in considerable detail with reference to certain preferred embodiments thereof, other embodiments are possible. For example, the rules based accounting of the present invention may readily be applied to single-entry bookkeeping by modifying the posting rules. In addition, the accounting system may be integrated with the custodian system, and/or the accounting system may generate events for each event in the life cycle of a transaction instead of the custodian system. Therefore, the spirit and scope of the appended claims should not be limited to the description of the preferred versions contained herein.

What is claimed is:

1. An accounting system for accounting for a plurality of events, each event associated with a transaction, using a plurality of accounting rules, where each transaction is associated with at least one of the plurality of accounting rules according to the type of transaction, said system comprising:
a transaction engine for receiving events from at least one source;
an accounting engine coupled to the transaction engine for deriving accounting information for the received events using for each received event at least one of the accounting rules associated with the type of the transaction of the received event; and
an accounting database coupled to the accounting engine for storing records of the derived accounting information.

2. The accounting system of claim 1, where the records of the derived accounting information are stored as postings to a plurality of ledger balances.

3. The accounting system of claim 1, where each transaction is associated with at least one of the plurality of accounting rules according to the type of transaction by being associated with a transaction classification, the transaction classification being associated with the at least one of a plurality of accounting rules.

4. The accounting system of claim 1, wherein the rules are updateable.

5. The accounting system of claim 1, wherein the rules are arranged in a posting matrix.

6. The accounting system of claim 1, wherein the rules are written using a scripting language.

7. A method for maintaining an account for a plurality of transaction events using a plurality of transaction rules, the account having a cost basis associated therewith, the transaction event being associated with an event type, a transaction classification and an asset classification, where each transaction event is associated with at least one of the plurality of accounting rules according to the at least one of the cost basis, event type, transaction classification and asset classification, the method comprising:
receiving a transaction event from at least one source;
determining at least one accounting rule to apply to the received transaction event based upon at least one of the cost basis, event type, transaction classification and asset classification; and
deriving accounting information for the received transaction event using the accounting rule or rules determined to apply to the transaction event.

8. A method for maintaining an account for a plurality of transaction events using a plurality of transaction rules, the method comprising:
receiving a transaction event from at least one source;
determining at least one accounting rule to apply to the received transaction event;
deriving accounting information for the received transaction event using the accounting rule or rules determined to apply to the transaction event; and
posting the derived accounting information to at least one ledger balance for the account.

9. The method of claim 9, wherein the account has a cost basis associated therewith, and the determining of at least one accounting rule to apply to the transaction event is based at least on the cost basis and the type of transaction event.

10. An accounting system having a plurality of accounting rules for maintaining an account for a plurality of transaction events, each transaction event having a date-time associated therewith, the system comprising:
a transaction engine for receiving transaction events, determining whether reconstruction is needed based on the date-time of the received transaction events and, based on the determination, reconstructing the account so that the received transactions are posted to the account in date-time order;
an accounting system, coupled to the transaction engine, for determining a set of accounting rules to apply to the received transaction events, deriving accounting information for the received transaction events according to the set of accounting rules; and
an accounting database coupled to the accounting system for storing derived accounting information for the transaction events.

11. The accounting system of claim 9, further comprising a user interface to maintain the plurality of accounting rules.
